(19) United States
(12) Patent Application Publication
(10) Pub. No.: US 2012/0002947 A1
(43) Pub. Date: Jan. 5, 2012

(54) APPARATUS AND METHOD FOR RECORDING AND PLAYING A MEDIA FILE, AND A RECORDING MEDIUM THEREFOR

(75) Inventors: Sung-Ryeul RHYU, Yongin-si (KR); Seo-Young HWANG, Suwon-si (KR); Jae-Yeon SONG, Seoul (KR)

(73) Assignee: Samsung Electronics Co., Ltd., Suwon-si (KR)

(21) Appl. No.: 13/039,840

(22) Filed: Mar. 3, 2011

(30) Foreign Application Priority Data
Mar. 3, 2010 (KR) 10-2010-0019203

(51) Int. Cl. H04N 9/80

(52) U.S. Cl. 386/248

(57) ABSTRACT

A method and recording apparatus for recording a media file onto a computer-readable recording medium. The apparatus includes a generator for generating a box including media data of a first content, a box including metadata information for playing the media data of the first content, a box including media data of a second content, and a box including metadata information for playing the media data of the second content, and a storage for storing the generated boxes. The box including the media data of the second content and the box including the metadata information for playing the media data of the second content each includes identification information for the second content.

### PRIORITY

This application claims priority under 35 U.S.C. §119(a) to a Korean Patent Application filed in the Korean Intellectual Property Office on Mar. 3, 2010 and assigned Serial No. 10-2010-0019203, the entire disclosure of which is hereby incorporated by reference.

### BACKGROUND OF THE INVENTION

1. Field of the Invention The present invention relates generally to transmitting content in accordance with a Moving Picture Experts Group (MPEG)-based media file format, and more particularly, to a media file recording and playing apparatus and method for transmitting content using an International Organization for Standardization (ISO)-based media file format, and a computer-readable recording medium therefor.

2. Description of the Related Art

The movie metadata box “MOOV” specified in the existing MPEG-4 Part12 ISO-based File Format can describe only one content item (with a plurality of resources). Therefore, in the existing ISO-based file format, there is no mention of a method or a structure for describing a plurality of content items. Depending on the existing ISO-based file format, because it is not assumed that multiple content items are transmitted, there is no way to distinguish a plurality of content items. Accordingly, while transmitting one content item, it is not possible to transmit another content item (or additional content) through the same transmission path as that of the one content item. However, to improve transmission efficiency and response time, it is advantageous to transmit a plurality of content item s at a single request.

The multi-transmission is useful even for transmission of the data that a client does not expect. For different content items related to, for example, a news update and an emergency, because the client cannot expect to receive them in advance, no request may be sent from the client to the server. Therefore, it is useful to transmit a plurality of content items through one communication channel.

### SUMMARY OF THE INVENTION

The present invention is designed to address at least the above-mentioned problems and/or disadvantages and to provide at least the advantages described below. Accordingly, an aspect of the present invention is to provide an apparatus and method for recording and playing a media data file specified in an ISO-based file format, and a recording medium therefor.

Another aspect of the present invention is to provide an apparatus and method for delivering a semantic of content and its relationship with the current content during transmission of multiple content items, and a recording medium therefor.

Another aspect of the present invention is to provide an apparatus and method for processing a semantic of content, its relationship with the current content, and transmitted content items, during transmission of a plurality of content items, and a recording medium therefor.

In accordance with an aspect of the present invention, a computer-readable recording medium is provided. The computer-readable recording medium includes a box including media data of a first content; a box including metadata information for playing the media data of the first content; a box including media data of a second content; and a box including metadata information for playing the media data of the second content. The box including the media data of the second content and the box including the metadata information for playing the media data of the second content each includes identification information for the second content.

In accordance with another aspect of the present invention, a computer-readable recording medium is provided. The computer-readable recording medium includes a first movie metadata (moov) box corresponding to a first media data (mdat) box corresponding to first content among a plurality of content and a first movie fragment (moof) box, and a second movie metadata box, which corresponds to a second media data box corresponding to second content, different from the first content, from among the plurality of content, and a second movie fragment box. The movie header data in the a second movie metadata box is different from movie header data included in the first movie metadata box.

In accordance with another aspect of the present invention, a recording apparatus for recording a media file is provided. The apparatus includes a generator for generating a box including media data of a first content, a box including metadata information for playing the media data of the first content, a box including media data of a second content, and a box including metadata information for playing the media data of the second content, wherein the box including the media data of the second content and the box including the metadata information for playing the media data of the second content each includes identification information for the second content; and a storage for storing the generated boxes.

In accordance with another aspect of the present invention, a recording apparatus for recording a media file is provided. The apparatus includes a generator for, generating a first movie metadata (moov) box corresponding to a first media data (mdat) box corresponding to first content among a plurality of content and a first movie fragment (moof) box, and generating a second movie metadata box, which corresponds to a second media data box corresponding to second content, different from the first content, from among the plurality of content and a second movie fragment box; and a storage for storing the generated first and second media data boxes, first and second movie fragment boxes, and first and second movie metadata boxes. The movie header data in the a second movie metadata box is different from movie header data included in the first movie metadata box.

In accordance with another aspect of the present invention, there is provided a playing apparatus for playing a media file. The apparatus includes an input unit for receiving a box including media data of a first content, a box including metadata information for playing the media data of the first content, a box including media data of a second content, and a box including metadata information for playing the media data of the second content, wherein the box including the media data of the second content and the box including the metadata information for playing the media data of the second content each includes identification information for the second content; a processor for parsing the received boxes and processing the media data to be displayed, using the parsed metadata information; and a display for displaying the media data parsed by the processor.

In accordance with another aspect of the present invention, a playing apparatus for playing a media file is provided. The apparatus includes an input unit for receiving a box including media data of each content and a stream including metadata information for playing the media data, for each of a plurality of different content; a processor for parsing, from the stream, a first movie metadata (moov) box corresponding to a first media data (mdat) box corresponding to first content among the plurality of content and a first movie fragment (moof) box, and parsing a second movie metadata box, which corresponds to a second media data box corresponding to second content, different from the first content, from among the plurality of content and a second movie fragment box; and a display for displaying the media data parsed by the processor. The movie header data in the a second movie metadata box is different from movie header data included in the first movie metadata box.

In accordance with another aspect of the present invention, there is provided a method for recording a media file onto computer-readable recording medium. The method includes generating a box including media data of a first content; generating a box including metadata information for playing the media data of the first content; generating a box including media data of a second content; generating a box including metadata information for playing the media data of the second content; and storing the generated boxes. The box including the media data of the second content and the box including the metadata information for playing the media data of the second content each includes identification information for the second content.

In accordance with another aspect of the present invention, a method for recording a media file is provided. The method includes generating a first movie metadata (moov) box corresponding to a first media data (mdat) box corresponding to first content among a plurality of content and a first movie fragment (moof) box, generating a second movie metadata box, which corresponds to a second media data box corresponding to second content, different from the first content, from among the plurality of content and a second movie fragment box, and storing the generated first and second media data boxes, first and second movie fragment boxes, and first and second movie metadata boxes. The movie header data in the a second movie metadata box is different from movie header data included in the first movie metadata box.

In accordance with another aspect of the present invention, there is provided a method for playing a media file. The method includes receiving a box including media data of a first content; receiving a box including metadata information for playing the media data of the first content; receiving a box including media data of a second content; receiving a box including metadata information for playing the media data of the second content; parsing, from the received boxes, identification information for identifying the second content; parsing the media data of the second content and the metadata information for playing the media data of the second content according to the identification information; and processing the media data to be displayed, using the parsed metadata information.

In accordance with another aspect of the present invention, a method for playing a media file is provided. The method includes receiving a box including media data of each content and a stream including metadata information for playing the media data, for each of a plurality of content; parsing, from the stream, a first movie metadata (moov) box corresponding to a first media data (mdat) box corresponding to first content among the plurality of content and a first movie fragment (moof) box, and parsing a second movie metadata box, which corresponds to a second media data box corresponding to second content, different from the first content, from among the plurality of content and a second movie fragment box; and displaying the parsed media data. The movie header data in the a second movie metadata box is different from movie header data included in the first movie metadata box.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a diagram conceptually illustrating a transmission of content according to an embodiment of the present invention;

FIG. 2 is a diagram illustrating a player in a receiver playing content according to an embodiment of the present invention;

FIG. 3 is a diagram illustrating a player in a receiver playing content according to an embodiment of the present invention;

FIG. 4 is a diagram illustrating a structure of a BBOX according to an embodiment of the present invention;

FIG. 5 is a diagram illustrating content being transmitted through boxes having IDEN boxes as their sub boxes according to an embodiment of the present invention;

FIG. 6 is a diagram illustrating an example of a structure of an IDEN box according to an embodiment of the present invention;

FIG. 7 is a diagram conceptually illustrating a transmission of content according to an embodiment of the present invention;

FIG. 8 is a diagram illustrating a general content structure based on an ISO-based media file format;

FIG. 9 is a diagram illustrating desirable operations of a content provider and a player, according to an embodiment of the present invention;

FIG. 10 is a diagram illustrating a similar box MOV2 serving as a MOOV box according to an embodiment of the present invention;

FIG. 11 is a flowchart illustrating a broadcast reception procedure according to an embodiment of the present invention;

FIG. 12 is a flowchart illustrating another a broadcast reception procedure according to an embodiment of the present invention;

FIG. 13 is a flowchart illustrating a method for recording media files according to an embodiment of the present invention;

FIG. 14 is a flowchart illustrating a method for recording media files according to an embodiment of the present invention;

FIG. 15 is a flowchart illustrating a method for recording media files according to an embodiment of the present invention;

FIG. 16 is a flowchart illustrating a method for recording media files according to an embodiment of the present invention;

FIG. 17 is a flowchart illustrating a method for playing media files according to an embodiment of the present invention;

FIG. 18 is a flowchart illustrating a method for playing media files according to an embodiment of the present invention;

FIG. 19 is a flowchart illustrating a method for playing media files according to an embodiment of the present invention;

FIG. 20 is a flowchart illustrating a method for playing media files according to an embodiment of the present invention;

FIG. 21 is a block diagram of a recorder according to an embodiment of the present invention; and

FIG. 22 is a block diagram of a player according to an embodiment of the present invention.

Throughout the drawings, the same drawing reference numerals will be understood to refer to the same elements, features and structures. Additionally, blocks illustrated with the same hatching shape (or shading) represent the same content.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of certain embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

The ISO-based media file format is defined in “Information technology-coding of audio-visual objects—part 12: ISO-based media file format” specified in the ISO/IEC international standard 14496-12:2005. A file in this format includes media data and metadata. A basic building block in the ISO-based media file format is called a “box”, and a box is an objected-oriented basic building block in the ISO-based media file format. Each box includes a header and a payload. A box header represents a type of the box and a size of the box in bytes. A plurality of specified boxes are derived from a “full box” structure in which a version number and a flag are included in the header. A box may include another box, and the ISO file format refers to the box type allowable within a box of a specific type.

Media data, e.g., an Audio/Video (A/V) file, is stored in a media data (mdat) box, metadata is stored in a MOOV box, and a file type is stored in a file type (ftyp) box. Accordingly, the ISO-based media file format has a plurality of boxes including A/V data and their detailed information. Herein, the term “box” may also be referred to as a data block or a container.

BBOX

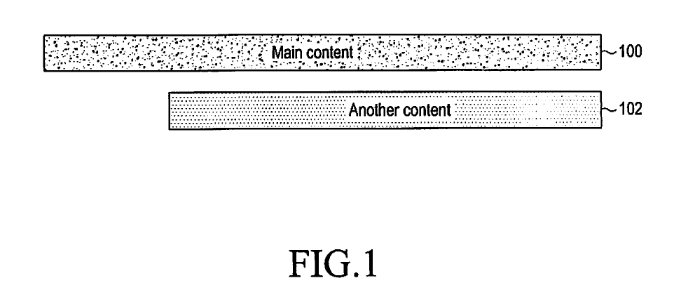

FIG. 1 is a diagram conceptually illustrating a transmission of content according to an embodiment of the present invention. Specifically, FIG. 1 illustrates transmission of another content (or additional content) 102 along with main content 100 according to an embodiment of the present invention.

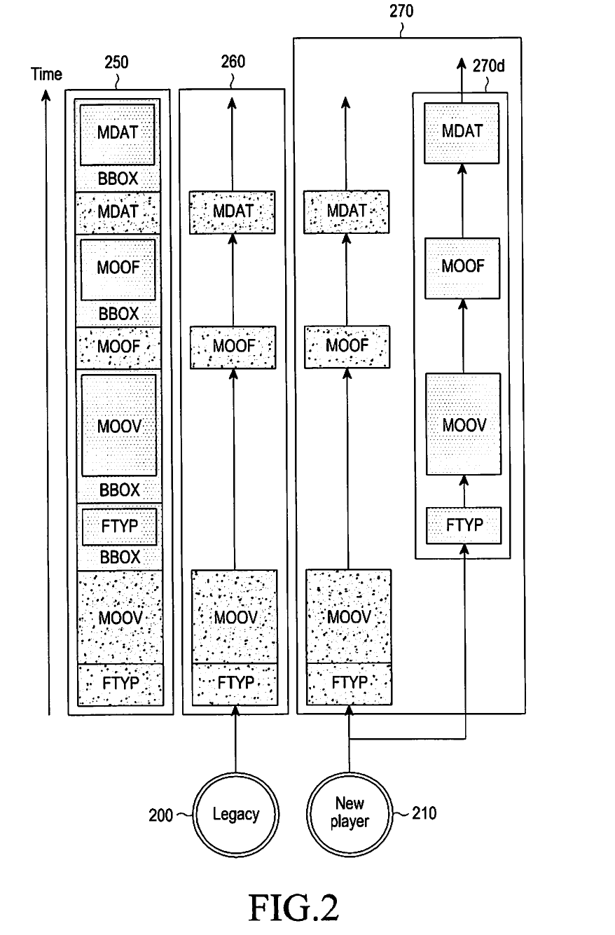

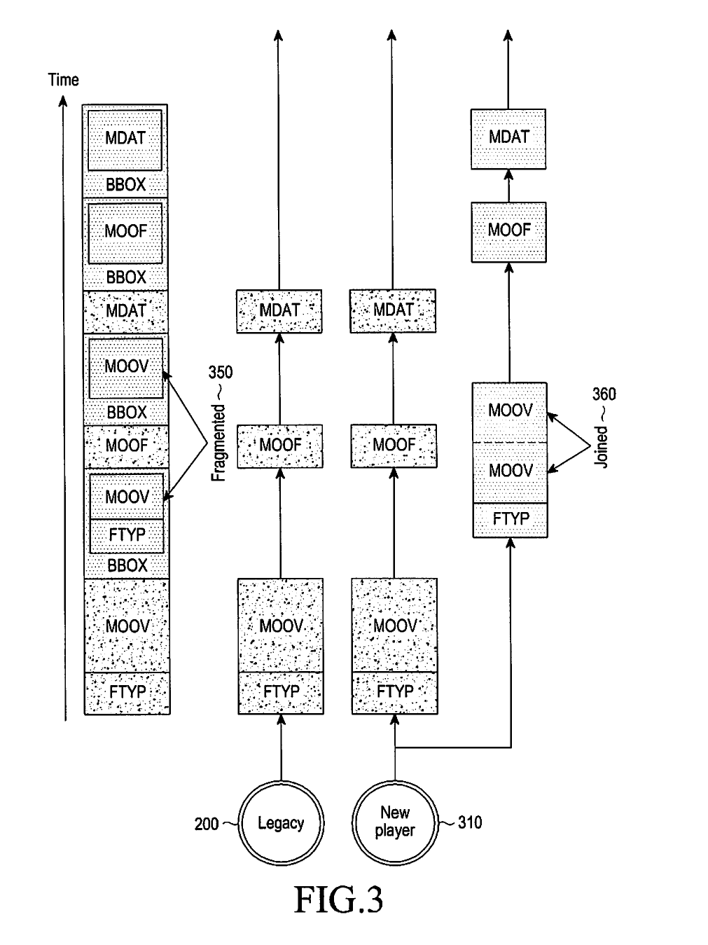

Referring to FIG. 1, data of another content 102 is segmented in units of boxes or chunks of an appropriate size, as will be described in more detail below with reference to in FIGS. 2 and 3. Each segment is included and transmitted as a payload of a new box (hereinafter referred to as a “BBOX”) proposed in accordance with an embodiment of the present invention.

FIG. 2 is a diagram illustrating a player in a receiver playing content according to an embodiment of the present invention. Specifically, FIG. 2 illustrates the another content 102 being segmented in units of boxes of an appropriate size before its transmission, and a player in a receiver plays main content 100 and another content 102 according to an embodiment of the present invention.

Referring to FIG. 2, reference numeral 250 represents a file structure according to an embodiment of the present invention.

According to an embodiment of the present invention, main content 100 having originally been transmitted is transmitted in the conventional MPEG-4 format, and only the another content 102 is transmitted in the form of a payload of a new box BBOX. Thus, both a legacy player 200 and a new player 210 have no problem in playing content.

When the main content 100 is received, the legacy player 200 may play main the content 100 as represented by reference numeral 260, without problem, because the main content 100 was transmitted in the conventional format. When the another content 102 is received, the legacy player 200 discards a BBOX, regarding it as an unknown box by parsing the BBOX.

However, when a BBOX arrives during content playback, the new player 210 identifies it as a notification indicating the arrival of multiple content items, and processes the BBOX according to the relationship between the main content 100 and the another content 102, and the purpose thereof For example, if the another content 102 includes an application describing the main content 100, e.g., a web page, a picture, a web link, an audio track such as a director commentary, and a second-language audio track, then the another content 102 may be processed as one or more tracks added to a plurality of tracks included in the main content 100.

As another example, if the another content 102 includes a notification about emergencies such as earthquakes, tsunamis, torrential rain, etc., then the new player 210 may simultaneously play a plurality of content items in such a manner that the another content 102 is located on top of the main content 100, covers the main content 100, or flickers on the main content 100, thereby drawing a user's attention thereto.

As another example, for a live broadcast, advertisements or information about follow-up programs to be transmitted in the middle or end of the live broadcast may generally be considered content items having already been created. In this scenario it is likely that a transmission side will transmit the live content with its maximum bandwidth, and will transmit the high-quality advertisements or follow-up program information at its minimum bit rate for a long time. In this case, although the another content 102 is transmitted together with the main content 100, the another content 102 is set to be subsequently played after the main content 100 is interrupted or terminated. The new player 210 adds and manages the another content 102 in its list as content to be played next.

FIG. 3 is a diagram illustrating a player in a receiver playing content according to an embodiment of the present invention. Specifically, FIG. 3 illustrates an example in which when a box including another content is segmented in units of chunks before its transmission, a player in a receiver plays main content and the another content according to an embodiment of the present invention. In FIG. 3, reference numeral 350 represents how data may be treated as something being transmitted like chunks, rather than boxes are divided or tied up in terms of semantics.

Referring to FIG. 3, a new player 310 parsing a BBOX according to an embodiment of the present invention, physically or logically distinguishes transmitted data of each content item using its content ID, and gathers and processes the data associated with each content item. Therefore, the new player 310 including a parser or a decoder for playing each content item, may play content as if one consecutive content were transmitted as represented by reference numeral 360.

In the conventional ISO-based file format, a file is divided in terms of semantics, and each part is treated as a box. However, dividing all available types of boxes into several boxes is not supported.

However, as illustrated in FIG. 3, while transmitting a box in a semantic unit as a payload of a BBOX, a transmission side splits the box in terms of non-semantic units such as a data length during its transmission, and the new player 310 or a reception side joins the payloads associated with each content ID as represented by reference numeral 360. Consequently, it is possible to divide a box of every kind into several boxes of an arbitrary size during transmission and to restore them during reception.

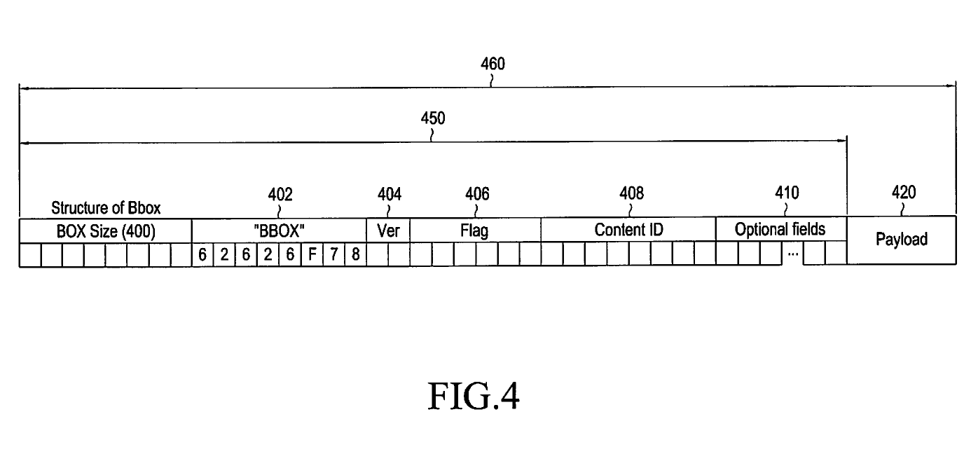

FIG. 4 illustrates a BBOX according to an embodiment of the present invention.

FIG. 4 illustrates a full box, which is one of the available box types in the conventional ISO-based file format, and a brand name 402 of the box is marked as ‘BBOX’ as designated in the present invention. As described above, because a format for representing a BBOX is the same as the scheme used in the conventional ISO-based file format, it can guarantee backward compatibility (i.e., it makes possible to determine whether the box is a box unknown to the legacy player).

As described above, however, because the brand mane 402, called a BBOX, does not belong to the type of the box ID that the legacy player can process, the legacy player skips the box size indicated by reference numeral 400 and processes the next box, determining this box as an unknown box.

A BBOX 460 according to an embodiment of the present invention is roughly divided into header information 450 and a payload 420. The payload 420 includes a file type box (an FTYP box), a movie metadata box (a MOOV box), a movie fragment box (a MOOF box), a media data box (an MDAT box), etc., and the header information 450 includes basic data fields such as a size field 400 of the BBOX 460, a BBOX ID field 402, a version field 404 representing version information of the BBOX 460, and a flag field 406. The header information 450 is set to provide a detailed description of the BBOX 460 using these basic data fields. Basically, the description may be made of relationships and operations the player should perform.

The size field 400 includes size information of the BBOX 460. The legacy player 200 may skip data corresponding to the size field 400 and receive a new box, because it treats the BBOX 460 as an unknown box. The flag field 406 includes a toggle bit indicating the either the presence or absence of optional fields 410.

The BBOX 460 is set to distinguish content included in the BBOX 460 from other content using a Content ID field 408. When transmitting two or more content items, a transmission side sends one of them in a conventional content format, wherein the transmission side cannot assign a content ID, because the conventional content is transmitted in the conventional method without using the BBOX representing a content ID. Therefore, it is preferable for another content using a BBOX to reserve a content ID of the conventional content as ‘0’ in order to indicate the conventional content.

It is preferable for the types of the optional fields 410 available in the BBOX 460 to include relationships between main content and another content (content included in the payload 420 of the BBOX 460), and operation instructions for the another content.

The relationships between the main content and the another content may include a spatial relationship on the screen, a playback time relationship, a structural relationship between the main content and the another content, a semantic of the another content with respect to the main content, etc.

Among the relationships between the main content and the another content, the spatial relationship, the time relationship, the structural relationship, the semantic of another content with respect to main content, and the operation instruction for another content will be described below, individually.

Spatial Relationship

As to the spatial relationship on the screen, details of order on the z-axis may be described, which indicate, for example, whether the another content is to be located over or under the main content.

The main content is reserved to be located in ‘0’ on the z-axis, and whether the another content is located over or under main content is expressed by a negative number or a positive number, thereby making it possible to describe spatial correlation between the main content and the another content when the content overlaps.

As to another spatial relationship on the screen, a size of the main content can be assumed to be the full resolution, and the location may be indicated at which the another content is located over the main content. Because a plurality of content items may be merged arbitrarily, the size of the main content may be described to map a left end on the horizontal axis to ‘0’ or ‘−1’, map a right end thereof to ‘1’, map a top end on the vertical axis to ‘0’ or ‘−1’, and map a bottom end thereof to ‘1’, such that the another content may be located in relative coordinates on the main content.

As to another spatial relationship on the screen, a size of the another content may be assumed to be the full resolution, and the main content may be described to be located in relative coordinates on the another content. As described above, when the main content has a size of (−1,−1)×(1,1), if the another content has a size of (−2,−2)×(2,2) and its location on the z-axis is represented by a negative number, the main content may be set to be located within the another content, like a picture frame.

As to another spatial relationship on the screen, the above-described spatial relationship information is used in a three-dimensional (3D) space. In this case, the another content includes information about figures (e.g., rectangles, circles, spheres, polygons, and other free-style models) in which relevant another content is being used as a texture. The another content further includes information about the location where its model is located in the 3D space. The another content further includes information about the location where a virtual camera is located in the 3D space. A player capable of playing content located in the 3D space using the above-described information may render content associated with an arbitrary time.

Another spatial relationship on the screen indicates a transition made when the main content and the another content are played sequentially or simultaneously. Generally, if the another content starts to be played or disappears suddenly in a moment, the user may recognize it as a problem. The another content may describe and prepare available in-effect and out-effect in advance, and instruct the player to use them together with an appropriate transition effect. Preferably, the another content may also include a duration of the transition.

As to another spatial relationship on the screen, the location where another content is located, may not be indicated by a number. In this case, if ‘full screen’, ‘partial screen’, ‘top of object on screen’, etc., are described in the front, rear, bottom, or side of the screen in terms of semantic, the player may map them to its own User Interface (UI) and use it in the form of Picture-in-Picture (PIP) and/or pop-up.

Time Relationship

As to the time relationship between the main content and the another content, a description of determining whether to simultaneously play the another content together with main content may be taken into consideration. If the description describes the simultaneously playback, the another content, upon its arrival, is played together with the main content on the player.

The another content may be described to be played in sync with the main content. For example, if playback of the main content is stopped by a user input, playback of the another content may also be stopped.

However, the another content may be described to be played out of sync with the main content. In this case, even though playback of the main content is stopped by a user input, the another content may continue to play. Similarly, even though playback of the another content is stopped by a user input, the main content may also continue to be play.

The another content to be played cannot be arbitrarily selected by the user because of an intention of a content producer. For example, with advertisements, the content producer may not want the user not to play the advertisements, or to play only the main content, by jumping or pausing the advertisements. Accordingly, a description may be specified in the another content to ban a user being able to avoid the another content.

The another content to be played may be described to be valid in any relative or absolute time. For example, after a lapse of a few minutes or several hours in relative time after thriller movie begins, question content may be played to give hints on a criminal or ask for the user's opinions. As another example, when content, such as highly anticipated film is set to be released at a specific time, if the film is played on all players at the specific time, proper viewing may not be ensured due to a server load or the like. However, if the film is transmitted in advance, and after the time in which the film is to be played is set in absolute time, it is possible for all viewers to simultaneously start playing the content without difficulties.

In addition, the another content may be described to be transmitted together with the main content, but played after the main content is terminated. As will be described below, as an operation to be performed on the another content, an operation of determining whether to store content may be described, and the stored another content is played after the main content is terminated or interrupted.

However, the another content may be described to be transmitted together with the main content, but played first, after interrupting the playback of the main content. For example, when the another content is an emergency update, the another content is played first, and the main content is stored and then played after the another content is terminated.

Structural Relationship

The main content and the another content are described to have an equal or dependent relationship. In the equal relationship, the content is played taking into account the spatial relationship and the time relationship. In case of the dependent relationship, a track of the another content is added to a track of the main content before its playback, as if it were part of the main content. For example, the another content may include at least one of an additional video track, an additional audio track, an additional subtitle track, and an additional metadata track, which are to be added to the main content before their playback.

Semantics

When the main content and the another content have arrived at a player, and the player waits for a user choice or plays the content without the choice by an intention of the content producer, an embodiment of the present invention describes a semantic of content to allow a viewer to determine which content or track is available and selected. For example, content may be displayed as an advertisement, and is described to have detailed semantics step-by-step such that the main content is a car advertisement and the another content is an advertisement of a model B for a car A. As another example, if semantics are described such as newsflash—public interest—earthquake—epicenter, then a player, which receives only the another content for the purpose of public interest and optionally plays it, can broadcast a warning to a plurality of unspecified persons.

Although such a player may play all content items of video plus audio, the player may determine a semantic, and if the semantic is set as speech, the player may convert the content into speech and broadcast it through a speaker. As another example, by transmitting regional weather or humidity information, and power consumption information, building air conditioning control, power consumption control, and illumination control are possible. In addition, control of public infrastructures (tunnels, traffic signal systems, bascule bridges, road lanes, dams, banks, etc.) may be achieved in connection with national disaster situations.

As another example, by transmitting traffic information, a broadcast is sent to prevent drivers from entering tunnels or express highways where accidents have occurred. A vehicle receiving the broadcast avoid entering the tunnel by combining location information and traffic information in the another content, to reduce its speed, or to determine a bypass.

Operation Instruction

The content producer may also designate whether the content is storable, not to be stored, or must be stored. Content transmitted in a BBOX includes such a description, and is prevented from being stored. For content that cannot be stored to prevent a player from storing or copying the content illegally, the content may be created such that data for playback undergoes late binding. For example, information contained in an MDAT box, such as a sample size of content chunks and the number of samples, is transmitted in another box such as a MOOV or MOOF box. If this box is transmitted through a separate channel, or transmitted in a different time, a player, which only stores the content chunks, cannot play the content.

If instructed to store content, the player should store the content. However, depending on the player, a size of the content to be stored may be greater than a size of an available space, or a size of the space emptied for other content to be stored may be less than a size of the content. For these cases, the minimum size or minimum range of content to be stored should be designated. The player stores content in advance according to the minimum size or range, and additionally downloads or streams the remaining non-stored data during playback in the playing time.

The above-described information representing relationships between the main content and the another content, i.e., the information about the spatial relationship, the time relationship, the structural relationship, the semantics, and the operation instruction, may be applied to the embodiments of the present invention as will be described below.

MDAT Extension

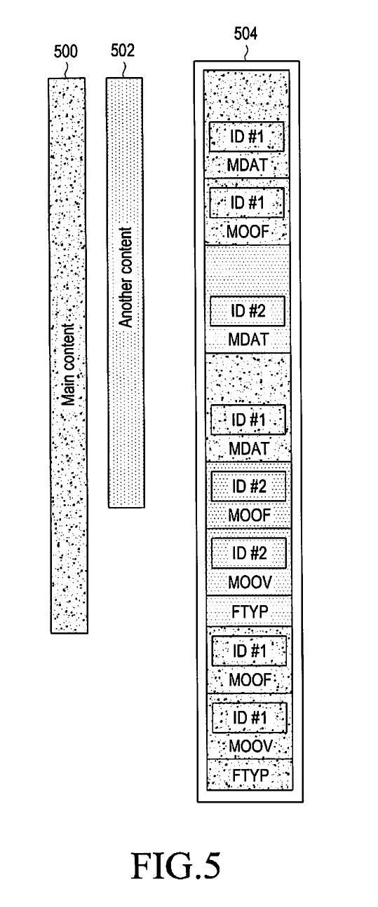

In accordance with an embodiment of the present invention, different content items are transmitted through the same transmission path in a mixed way as represented by reference numeral 504 in FIG. 5. For identification of the different content items, each content item is assigned its unique identifier (hereinafter referred to as an ‘IDEN’).

FIG. 5 is a diagram illustrating content being transmitted through boxes having IDEN boxes as their sub boxes according to an embodiment of the present invention.

Specifically, FIG. 5 illustrates two different content items, i.e., main content 500 and another content 502, being transmitted through boxes having their IDEN boxes according to an embodiment of the present invention.

Referring to FIG. 5, each IDEN box includes an ID of its content and information about a spatial relationship, a time relationship, a structural relationship, and a content semantic between the two content items.

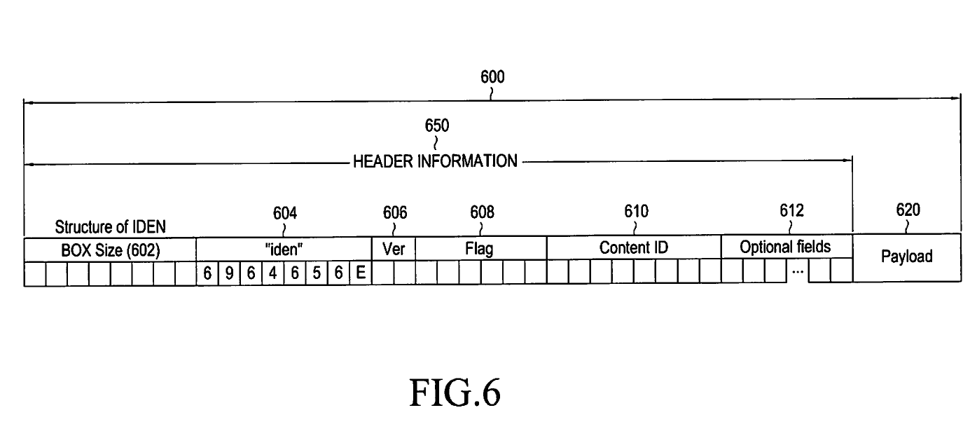

FIG. 6 illustrates an example of a structure of an IDEN box 600 according to the second embodiment of the present invention.

Referring to FIG. 6, the IDEN box 600 includes a payload 620, which includes media data and metadata information for playing the media data. The IDEN box 600 also includes header information 650, which includes a box size field 602, an IDEN box ID field 604, a version information field 606, a flag field 608, and a content ID field 610.

The box size field 602 represents a size of the IDEN box 600, and the IDEN box ID field 604 includes information indicating an ID for identifying the IDEN box 600. The version information field 606 includes version information of the IDEN box 600, and the flag field 608 includes a toggle bit for optional fields 612, and plays the same role as the flag field 406 as illustrated in FIG. 4.

The content ID field 610 includes an ID of the content, to which the media data or metadata included in the payload 620 corresponds, and the optional fields 612 are equivalent to the optional fields 410 as illustrated in FIG. 4.

The IDENs are included in superordinate boxes specified in the ISO-based media format standard, such as a movie fragment (MOOF) box, a movie fragment random access (MFRA) box, a media data (MDAT) box, a FREE box, a SKIP box, a metadata (META) box, and an additional metadata container (MECO) box.

A spatial relationship, a time relationship, a structural relationship, and a content semantic of each IDEN are the same as those described above.

Accordingly, a player extracts the IDEN box ID field 604 from the input stream, and determines if a relevant box is an IDEN box. If so, the player processes data contained in the payload 620 of the content indicated by the content ID field 610, determining that a plurality of contents were transmitted.

MOOV Extension

In the ISO-based file format or the prior art to be improved by the present invention, a MOOV box is limited so as not to come more than once. However, in accordance with an embodiment of the present invention, a play procedure of a player is provided for so that the MOOV box is extended to come more than once. In addition, an embodiment provides a play procedure for MOV2, which is a new box replacing the MOOV box.

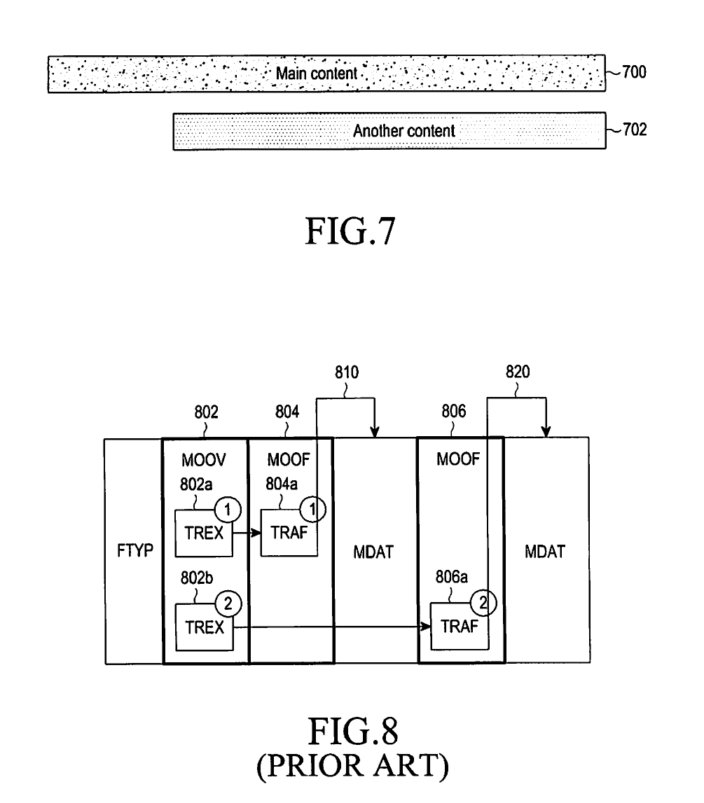

FIG. 7 is a diagram conceptually illustrating a transmission of content according to an embodiment of the present invention. Specifically, FIG. 7 illustrates another content 702 that will be transmitted during transmission of main content 700 according to an embodiment of the present invention.

FIG. 8 illustrates a general content structure based on an ISO-based media file format.

Referring to FIG. 8, a track extents (trex) 1 box 802a and a trex 2 box 802b described in a MOOV box 802 are added through a fragment structure that uses MOOF boxes 804 and 806. In the MOOV box 802, the trex 1 box 802a designates a track fragment (TRAF) 1 box 804a included in the MOOF box 804, and the trex 2 box 802b designates a TRAF 2 box 806a included in the MOOF box 806. The TRAF 1 box 804a designates the location where media data is located in its following MDAT box, as represented by reference numeral 810. The TRAF 2 box 806a also designates the location where media data is located in its following MDAT box, as represented by reference numeral 820. However, because of the limitation that MOOV may exist only once, it is not possible that another content is transmitted in the form of a new track or a trex 3 box.

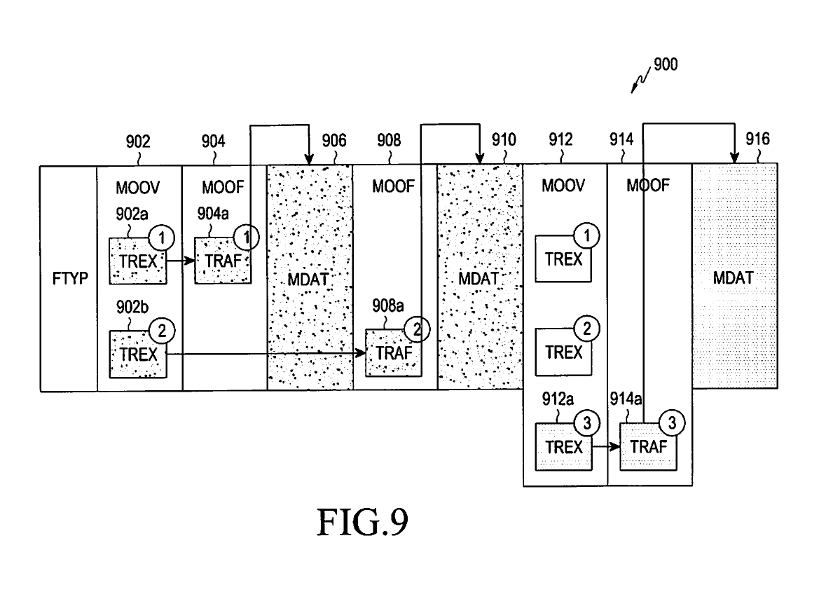

FIG. 9 illustrates operations of a content provider and a player when a MOOV box may exist more than once in a file, according to an embodiment of the present invention.

Referring to FIG. 9, reference numeral 900 illustrates a file structure in an ISO-based media file format according to an embodiment of the present invention. It is noted that two MOOV boxes 902 and 912 exist in the file. Like this, in accordance with an embodiment of the present invention, to transmit new content, a MOOV box including information about the new content is added to the conventional file structure.

More specifically, a player parses a trex 1 box 902a and a trex 2 box 902b included in a MOOV box 902, and refers to a traf 1 box 904a in a MOOF box 904 and a traf 2 box 908a in a MOOF box 908, which are indicated by the parsed trex 1 box 902a and trex 2 box 902b, respectively. Further, the player parses media data included in MDAT boxes 906 and 910, using information in the traf 1 box 904a and the traf 2 box 908a, respectively. If a new MOOV box 912 exists, the player parses a newly added trex 3 box 912a, which is not present in the previous MOOV box 902, and plays media data existing in a MDAT box 916 according to the information included in a traf 3 box 914a in a MOOF box 914, to which the trex 3 box 912a refers.

Referring to FIG. 9, it is noted that the MDAT boxes 906, 910, and 916, and the MOOF boxes 904, 908, and 914 are paired, respectively. It is also noted that the MOOV box 902 corresponds to a pair of the MOOF box 904 and MDAT box 906 and a pair of the MOOF box 908 and MDAT box 910, and the MOOV box 912 has data different from the data included in the MOOV box 902.

A recorder for recording data of the media file format illustrated in FIG. 9, records, in a computer-readable recording medium, a first MOOV box 902 corresponding to at least one first ‘mdat’ box 906 (910) corresponding to first content 700 among a plurality of content and a first ‘moof’ box 904 (908), and also records a second MOOV box 912, which corresponds to at least one second ‘mdat’ box 916 corresponding to second content 702, which is different than the first content 700, among the plurality of content and a second ‘moof’ box 914. The MOOV data in the second MOOV box 912 is different from the MOOV data included in the first MOOV box 902.

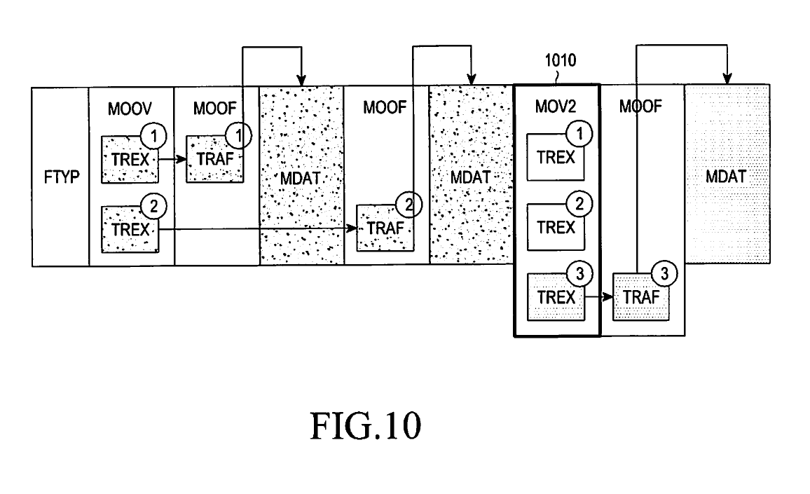

FIG. 10 illustrates a similar box MOV2 1010 serving as a MOOV box according to another embodiment of the present invention, to show the possibility of the following operation without the MOOV box.

When only one MOOV box can be located in the ISO-based media file format, i.e., the two MOOV boxes cannot be located therein as illustrated in FIG. 9, as illustrated in FIG. 10, in accordance with another embodiment, a MOOV box including a new trex box ‘trex 3’ 912a capable of referencing the MDAT box 916 having media data of another content is assigned a new name a MOV2 box 1010.

A method proposed by an embodiment of the present invention provides another content in the form of the third track (trak) using the MOOV box 912. Although ‘trak’ boxes are not explicitly illustrated in FIGS. 9 and 10, the trak boxes are included in the MOV2 box 1010 serving as a MOOV box with respect to the MOOV boxes 902 and 912 in FIG. 9 and another content 702 in FIG. 10, in accordance with the ISO-based media file format.

The player detects a difference between the previously received MOOV box 902 and the newly received MOOV box 912 through comparison, and in the presence of any track added or deleted, changes settings of the playback environment according thereto.

Although not illustrated in FIGS. 9 and 10, according to an embodiment of the present invention, boxes, which may be included in the new MOOV box 912 or the MOV2 box 1010, may include a track (trak) box specified in the ISO-based media format and its sub box, or may include a movie extension (mvex) box and its sub box.

Using the MOOV box more than once is useful for transmission of multiple content items, and also for transmission of a single content. For example, in a conventional digital broadcast, if a channel is changed, information corresponding to a program list is periodically transmitted, and channel switching is performed using this information. As a typical example, Program Map Table (PMT) information may be considered, which is transmitted when MPEG-2 TS is used. However, in order to use the ISO-based File Format for transmission of broadcast content, there is no box, which periodically provides information about content configuration and decoder configuration to the player, whose user intends to switch and watch a channel during transmission of content. Therefore, a periodically repeated box is required for broadcast, and this may be achieved using a plurality of MOOV boxes.

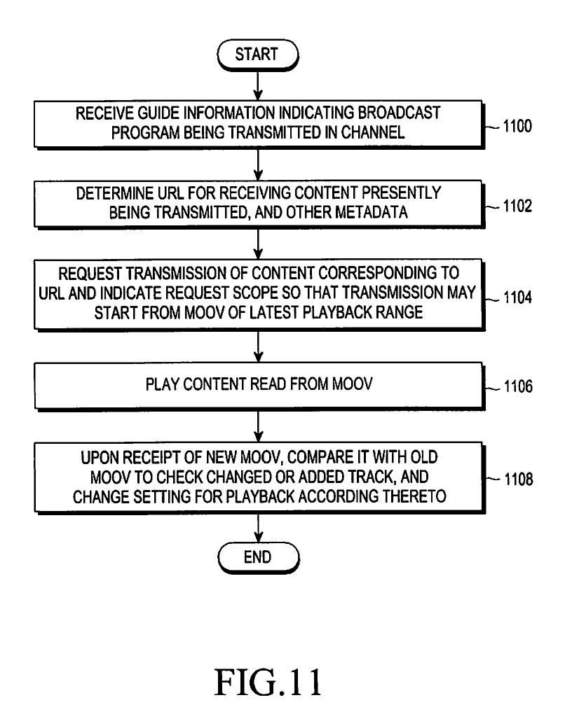

FIG. 11 illustrates a procedure in which a player performs broadcast reception according to an embodiment of the present invention.

Referring to FIG. 11, in step 1100, a player, which can receive broadcast content upon request, receives guide information representing broadcast programs being transmitted in a channel, e.g., metadata information such as Electronic Program Guide (EPG) information and Really Simple Syndication (RSS) information. In step 1102, the player determines a Uniform Resource Location (URL) or other metadata for receiving content being transmitted, e.g., determines the location where a MOOV box in a most recent playback range is located.

In step 1104, in order to receive the content being transmitted, the player indicates a request range so that the transmission may start from a MOOV box in the most recent playback range, while requesting transmission of the content corresponding to the URL. In step 1106, the player plays the content read from the MOOV box.

In step 1108, upon receiving a new MOOV box, the player determines the presence or absence of a changed or added track, by comparing the received new MOOV box with the exiting MOOV box, and changes settings for playback according to the determination results.

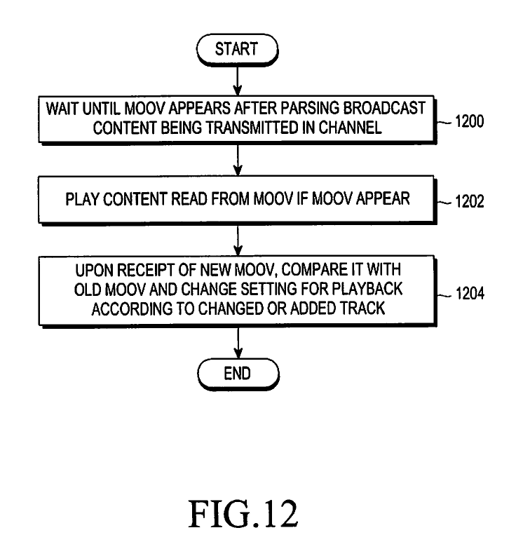

FIG. 12 illustrates another procedure in which a player performs broadcast reception according to an embodiment of the present invention.

Referring to FIG. 12, in step 1200, a player, which can receive multicast broadcast content, parses broadcast content being transmitted in a channel, and waits until a MOOV box appears.

In step 1202, if a MOOV box appears, the player starts reading content from the MOOV box and plays the read content.

In step 1204, upon receipt of a new MOOV box, the player determines the presence or absence of a changed or added track, by comparing the received new MOOV box with the existing MOOV box, and changes settings for playback according thereto.

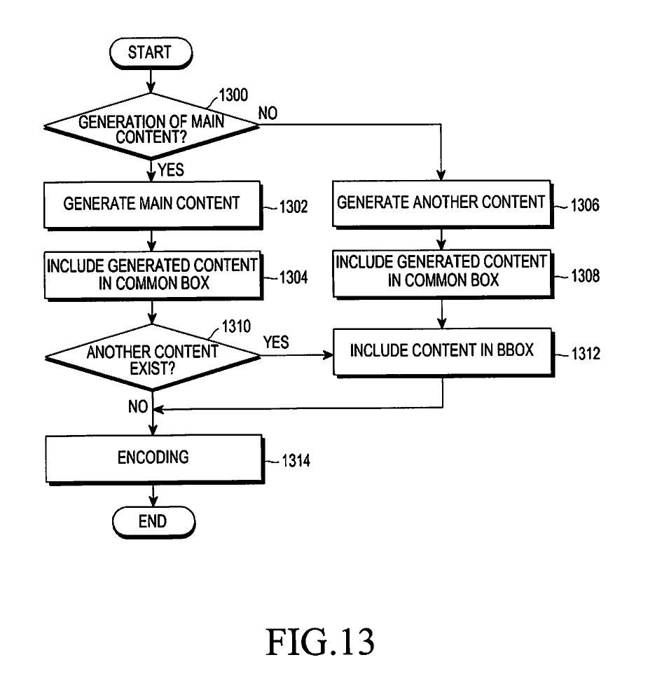

FIG. 13 illustrates a method for recording media files according to an embodiment of the present invention.

Referring to FIG. 13, in step 1300, a recorder determines whether a media file to be generated is main content. If so, the recorder generates main content in step 1302. The recorder includes the generated main content in a box specified in the ISO-based media file format in step 1304, and determines in step 1310 whether another content exists. If another content is not present in step 1310, the recorder encodes and stores the box in step 1314.

However, if another content is present in step 1310, the recorder includes the box with another content in a BBOX in step 1312.

If the media file to be generated is not main content in step 1300, the recorder generates another content in step 1306, includes the generated another content in a box specified in the ISO-based media file format in step 1308, includes the box with another content in a BBOX in step 1312, and stores the box in step 1314.

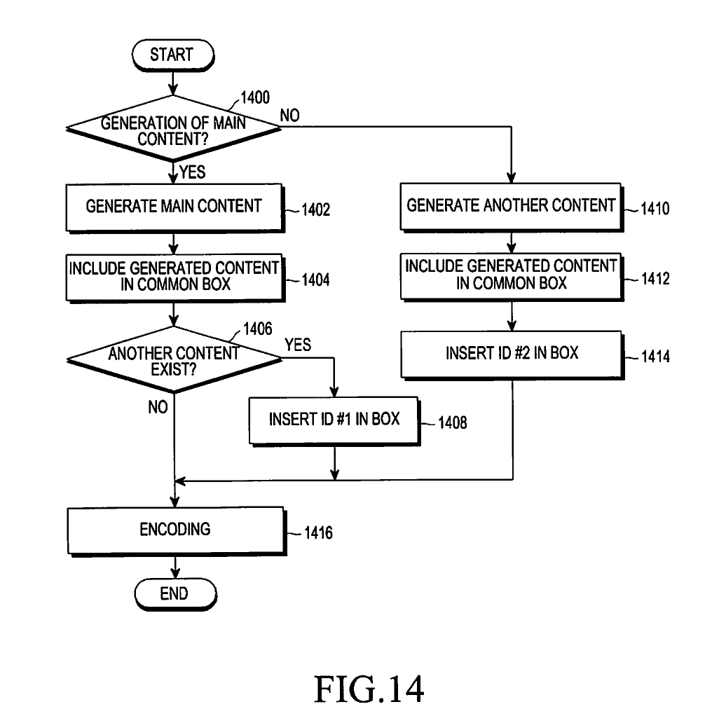

FIG. 14 illustrates a method for recording media files according to an embodiment of the present invention.

Referring to FIG. 14, in step 1400, a recorder determines whether relevant content is main content. If so, the recorder generates main content in step 1402, and includes the generated main content in a box specified in the ISO-based media file format in step 1404. If there is not another content present in step 1406, the recorder encodes and stores the common box in step 1416. However, if another content is present in step 1406, the recorder inserts an IDEN box with ID#1 in a payload of the box generated in step 1404, as a sub box in step 1408, and then encodes and stores the box in step 1416.

If the relevant content is not main content in step 1400, the recorder generates another content in step 1410, includes the generated another content in a box specified in the ISO-based media file format in step 1412, inserts an IDEN box with ID#2 in a payload of the generated box as a sub box in step 1414, and then encodes and stores the box in step 1416.

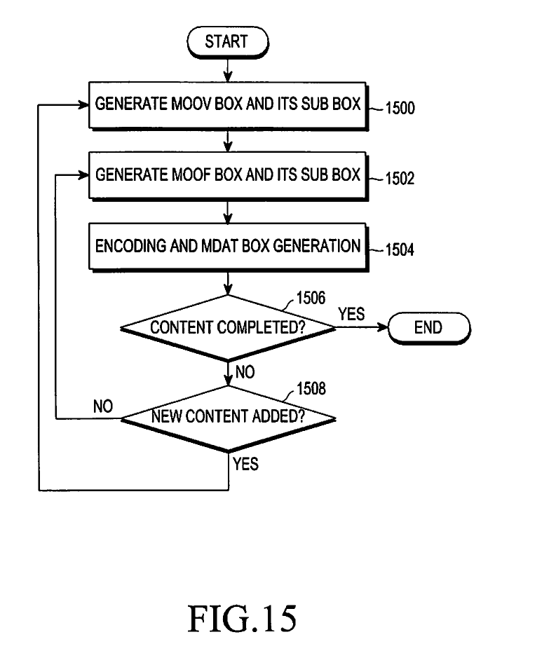

FIG. 15 illustrates a method for recording media files according to an embodiment of the present invention.

Referring to FIG. 15, a recorder generates a MOOV box and its sub boxes in step 1500, and generates a MOOF box and its sub boxes in step 1502. In step 1504, the recorder encodes a media data file, and then generates an MDAT box.

In step 1506, the recorder determines if the content creation is completed, and ends the method if the content creation is completed. However, if the content creation is not completed, the recorder determines whether new content has been added in step 1508. If new content has been added, the method returns to step 1500. If new content has not been added, the method returns to step 1502.

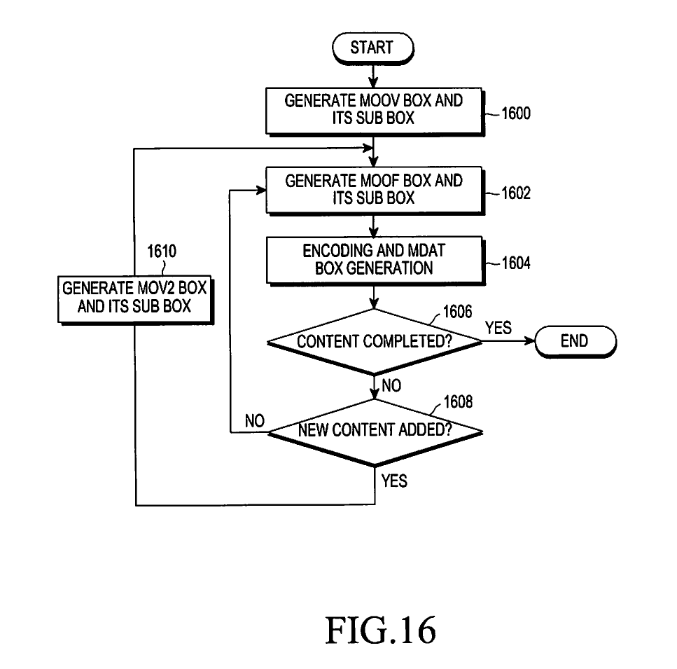

FIG. 16 illustrates a method for recording media files according to an embodiment of the present invention.

Referring to FIG. 16, a recorder generates a MOOV box and its sub boxes in step 1600, and generates a MOOF box and its sub boxes in step 1602. In step 1604, the recorder encodes the media data file, and then generates an MDAT box.

In step 1606, the recorder checks if the content creation is completed, and ends the method if the content creation is completed. However, if the content creation is not completed, the recorder determines whether new content has been added in step 1608. If new content has been added, the recorder generates a MOV2 box and its sub boxes in step 1610, and then the method returns to step 1602. That is, if new content is added in step 1608, the recorder generates a MOV2 box defined in FIG. 10, instead of the MOOV box, and its sub boxes in step 1610, and then proceeds to step 1602. If new content has not been added, the method returns to step 1602.

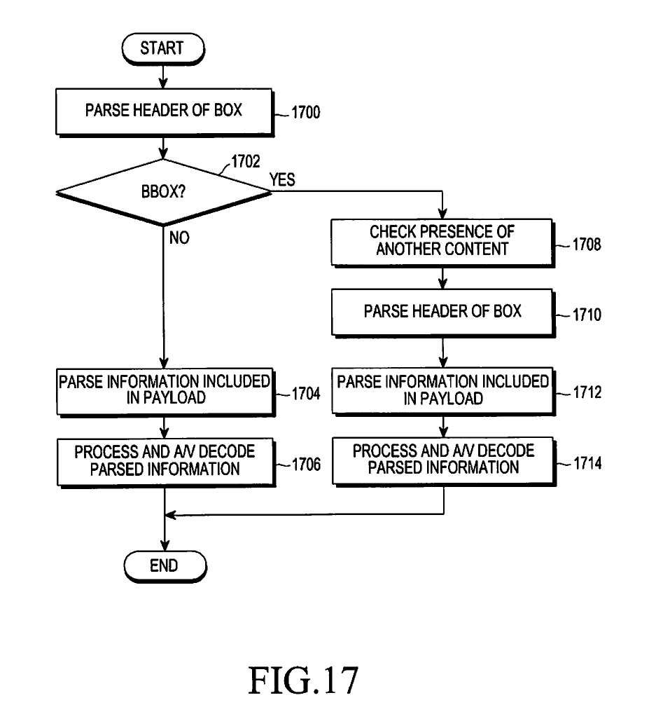

FIG. 17 illustrates a method for playing media files according to an embodiment of the present invention.

Referring to FIG. 17, a player parses a header of a box from an input stream in step 1700, and determines whether the box is a BBOX in step 1702. If the box is not a BBOX, the player parses information included in a payload of the box in step 1704, and processes the parsed information and plays media data by A/V decoding according to the parsed information in step 1706.

However, if the box is a BBOX in step 1702, the player recognizes the presence of another content in step 1708, and parses a header of the box in step 1710. The player parses information included in a payload of the box in step 1712, and processes the parsed information and plays media data by A/V decoding according to the parsed information in step 1714.

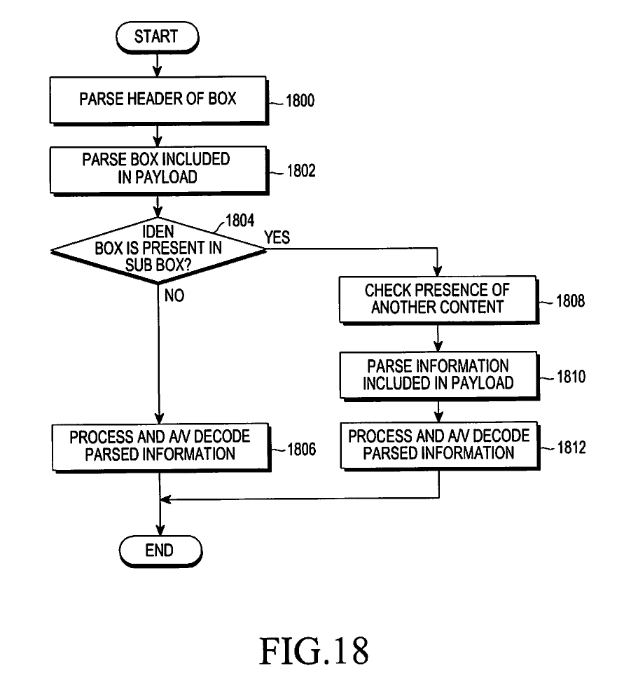

FIG. 18 illustrates a method for playing media files according to an embodiment of the present invention.

Referring to FIG. 18, a player parses a header of a box from an input stream in step 1800, and parses a sub box included in a payload of the box in step 1802. In step 1804, the player checks if an IDEN box is present in the sub box. In the absence of the IDEN box, the player processes the parsed information and plays media data by A/V decoding according to the parsed information in step 1806.

However, when the sub box includes an IDEN box, the player recognizes the presence of another content in step 1808, and parses information included in a payload of the box in step 1810. The player processes the parsed information and plays media data by A/V decoding according to the parsed information in step 1812.

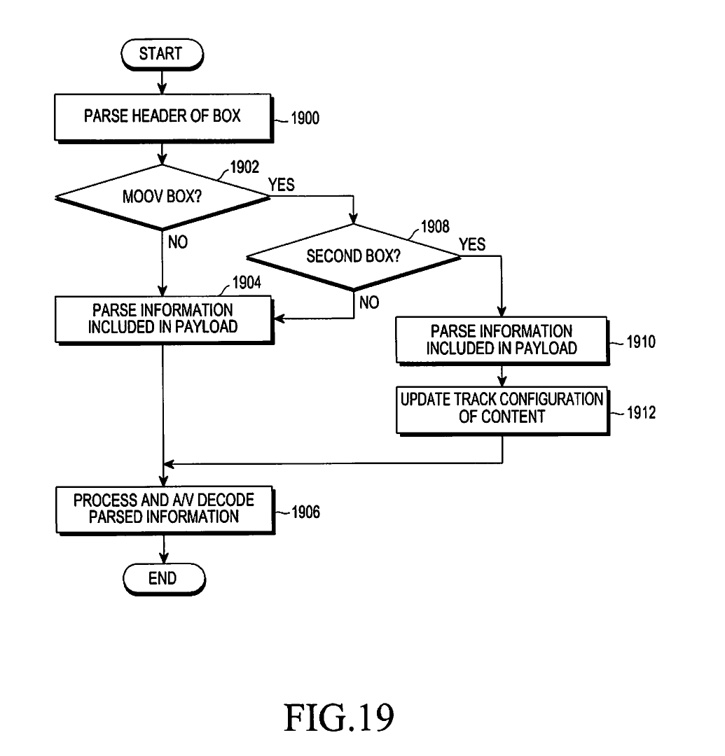

FIG. 19 illustrates a method for playing media files according to an embodiment of the present invention.

Referring to FIG. 19, a player parses a header of a box from an input stream in step 1900, and based on the parsed information, determines whether the box is a MOOV box in step 1902. If the box is not a MOOV box, the player parses information included in a payload in step 1904, and processes the parsed information and plays media data by A/V decoding according to the parsed information in step 1906.

However, if the box is a MOOV box, the player determines in step 1908 whether the MOOV box is a second or later MOOV box. If not a second or later MOOV box, the method proceeds to step 1904. However, if the MOOV box is a second or later MOOV box, the player parses information included in a payload in step 1910, recognizing that the MOOV box is a MOOV box of another content rather than main content. In step 1912, the player updates track information of the content, and then proceeds to step 1906.

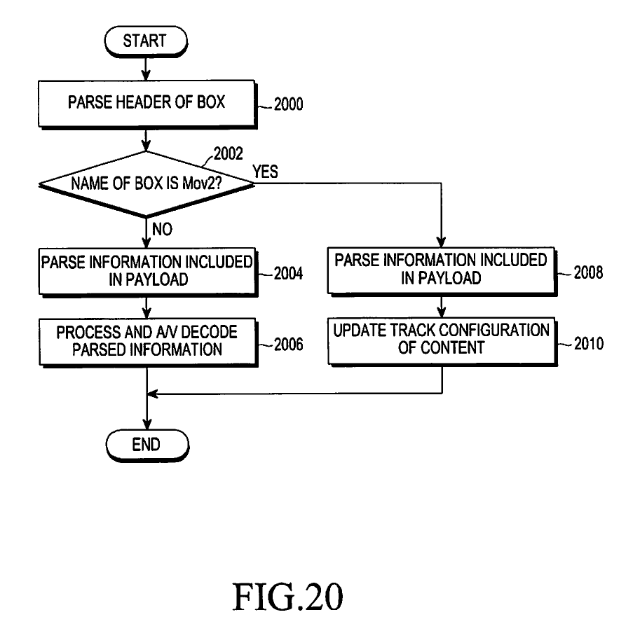

FIG. 20 illustrates a method for playing media files according to an embodiment of the present invention.

Referring to FIG. 20, a player parses a header of a box from an input stream in step 2000, and determines in step 2002 whether a name of the parsed header is a MOV2 box. If a name of the parsed header is not a MOV2 box, the player parses information included in a payload in step 2004, and processes the parsed information and plays media data by AN decoding according to the parsed information in step 2006.

However, if a name of the parsed header is a MOV2 box in step 2002, the player parses information included in a payload in step 2008, determining that the content is another content rather than main content, and updates track configuration information of the content in step 2010.

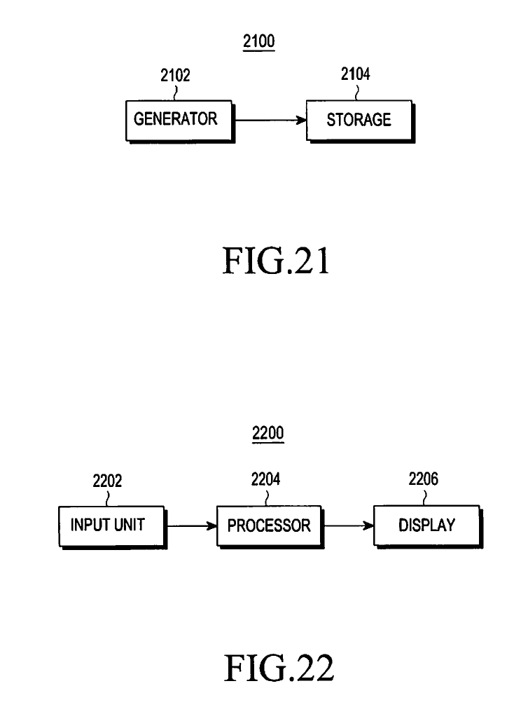

FIG. 21 is a block diagram of a recorder 2100 according to an embodiment of the present invention.

Referring to FIG. 21, a recorder 2100 includes a generator 2102 that generates ISO-based media files according to the above-described embodiments of the present invention, and stores them in a storage 2104.

More specifically, the generator 2102 generates a box including media data of each of a plurality of different content items and a box including metadata information for playing the media data, and inserts identification information for identifying at least one second content among the plurality of content items, into a box including media data of the second content and a box including metadata information for playing the media data of the second content. The storage 2104 stores the boxes generated by the generator 2102.

Additionally, the generator 2102 generates a media data (mdat) box of at least one of the plurality of different content items and a movie fragment (moof) box in a pair, generates a first movie metadata (moov) box to correspond to a pair of at least one first media data (mdat) box corresponding to first content among the plurality of content items and a first movie fragment (moof) box, and generates a second movie metadata (moov) box to correspond to a pair of at least one second media data (mdat) box corresponding to second content among the plurality of content items and a second movie fragment (moof) box and to have movie header data that is different from movie header data included in the first movie metadata (moov) box. The storage 2104 stores the first and second media data (mdat) boxes, the first and second movie fragment (moof) boxes, and the first and second movie metadata (moov) boxes, generated by the generator 1202.

FIG. 22 is a block diagram of a player 2200 according to an embodiment of the present invention.

Referring to FIG. 22, the player 2200 includes an input unit 2202 that receives media files and outputs them to a processor 2204. More specifically, the input unit 2202 receives a box including media data of each of a plurality of different contents and a box including metadata information needed to play the media data.

According to the above-described embodiments of the present invention, the processor 2204 parses the input boxes, parses identification information for identifying at least one second content from among the plurality of content items, parses media data of the second content and metadata information for playing the media data of the second content according to the identification information, and controls a display 2206 to display the media data using the parsed metadata information.

Additionally, the processor 2204 parses a first movie metadata (moov) box, which corresponds to a pair of at least one first media data (mdat) box corresponding to first content among the plurality of content items and a first movie fragment (moof) box, and parses a second movie metadata (moov) box, which corresponds to a pair of at least one second media data (mdat) box corresponding to second content from among the plurality of content items and a second movie fragment (moof) box and has movie header data that is different from movie header data included in the first movie metadata (moov) box. The display 2206 displays the media data parsed by the processor 2204.

When a program is performed, a computer-readable recording medium including software according to the present invention controls an apparatus to perform a method that includes recording a box including media data of a first content, recording a box including metadata information for playing the media data of the first content, recording a box including media data of a second content, and recording a box including metadata information for playing the media data of the second content. The box including the media data of the second content and the box including the metadata information for playing the media data of the second content each includes identification information for the second content.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A computer-readable recording medium comprising:
a box including media data of a first content;
a box including metadata information for playing the media data of the first content;
a box including media data of a second content; and
a box including metadata information for playing the media data of the second content,
wherein the box including the media data of the second content and the box including the metadata information for playing the media data of the second content each includes identification information for the second content.

2. The computer-readable recording medium of claim 1, wherein the box including media data of the second content includes a media data (mdat) box.

3. The computer-readable recording medium of claim 1, wherein the box including metadata information for playing the media data of the second content includes at least one of a file type (ftyp) box, a movie metadata (moov) box, and a movie fragment (moof) box.

4. The computer-readable recording medium of claim 1, wherein the identification information for the second content is included in header information for identifying the box including the media data of the second content and the box including the metadata information for playing the media data of the second content, respectively.

5. The computer-readable recording medium of claim 1, wherein the identification information for the second content includes a content identifier for identifying the second content corresponding to the media data contained in a payload of the box, or identifying the second content corresponding to the metadata of the media data.

6. The computer-readable recording medium of claim 1, wherein the header information includes at least one of information indicating a spatial relationship on a screen between the first content and the second content, information indicating a time relationship between the first content and the second content, and information indicating a semantic of the second content with respect to the first content.

7. A computer-readable recording medium comprising:
a first movie metadata (moov) box corresponding to a first media data (mdat) box corresponding to first content among a plurality of content and a first movie fragment (moof) box; and
a second movie metadata box, which corresponds to a second media data box corresponding to second content, different from the first content, from among the plurality of content, and a second movie fragment box,
wherein movie header data in the a second movie metadata box is different from movie header data included in the first movie metadata box.

8. The computer-readable recording medium of claim 7, wherein the movie header data includes at least one of a track (trak) box and a movie extension (mvex) box.

9. A recording apparatus for recording a media file, the apparatus comprising:
a generator for generating a box including media data of a first content, a box including metadata information for playing the media data of the first content, a box including media data of a second content, and a box including metadata information for playing the media data of the second content, wherein the box including the media data of the second content and the box including the metadata information for playing the media data of the second content each includes identification information for the second content; and
a storage for storing the generated boxes.

10. The recording apparatus of claim 9, wherein the box including the media data of the second content comprises a media data (mdat) box.

11. The recording apparatus of claim 9, wherein the box including the metadata information for playing the media data of the second content comprises at least one of a file type (ftyp) box, a movie metadata (moov) box, and a movie fragment (moof) box.

12. The recording apparatus of claim 9, wherein the identification information for the second content is included in header information for identifying the box including the media data of the second content and the box including the metadata information for playing the media data of the second content, respectively.

13. The recording apparatus of claim 9, wherein the identification information for the second content comprises a content identifier for identifying the second content corresponding to the media data included in a payload of the box, or identifying the second content corresponding to the metadata of the media data.

14. The recording apparatus of claim 9, wherein the header information comprises at least one of information indicating a spatial relationship on a screen between the first content and the second content, information indicating a time relationship between the first content and the second content, and information indicating a semantic of the second content with respect to the first content.

15. A recording apparatus for recording a media file, the apparatus comprising:
a generator for,
generating a first movie metadata (moov) box corresponding to a first media data (mdat) box corresponding to first content among a plurality of content and a first movie fragment (moof) box, and
generating a second movie metadata box, which corresponds to a second media data box corresponding to second content, different from the first content, from among the plurality of content and a second movie fragment box; and
a storage for storing the generated first and second media data boxes, first and second movie fragment boxes, and first and second movie metadata boxes,
wherein movie header data in the a second movie metadata box is different from movie header data included in the first movie metadata box.

16. The recording apparatus of claim 15, wherein the movie header data comprises at least one of a track (trak) box and a movie extension (mvex) box.

17. A playing apparatus for playing a media file, the apparatus comprising:
an input unit for receiving a box including media data of a first content, a box including metadata information for playing the media data of the first content, a box including media data of a second content, and a box including metadata information for playing the media data of the second content, wherein the box including the media data of the second content and the box including the metadata information for playing the media data of the second content each includes identification information for the second content;
a processor for parsing the received boxes and processing the media data to be displayed, using the parsed metadata information; and
a display for displaying the media data parsed by the processor.

18. The playing apparatus of claim 17, wherein the box including media data of the second content comprises a media data (mdat) box.

19. The playing apparatus of claim 17, wherein the box including metadata information for playing the media data of the second content comprises at least one of a file type (ftyp) box, a movie metadata (moov) box, and a movie fragment (moof) box.

20. The playing apparatus of claim 17, wherein the identification information for the second content is included in header information for identifying the box including the media data of the second content and the box including the metadata information for playing the media data of the second content, respectively.

21. The playing apparatus of claim 17, wherein the identification information for the second content comprises a content identifier for identifying the second content corresponding to the media data contained in a payload of the box, or identifying the second content corresponding to the metadata of the media data.

22. The playing apparatus of claim 17, wherein the header information comprises at least one of information indicating a spatial relationship on a screen between the first content and the second content, information indicating a time relationship between the first content and the second content, and information indicating a semantic of the second content with respect to the first content.

23. A playing apparatus for playing a media file, the apparatus comprising:
an input unit for receiving a box including media data of each content and a stream including metadata information for playing the media data, for each of a plurality of different content;
a processor for,
parsing, from the stream, a first movie metadata (moov) box corresponding to a first media data (mdat) box corresponding to first content among the plurality of content and a first movie fragment (moof) box, and
parsing a second movie metadata box, which corresponds to a second media data box corresponding to second content, different from the first content, from among the plurality of content and a second movie fragment box; and
a display for displaying the media data parsed by the processor,
wherein movie header data in the a second movie metadata box is different from movie header data included in the first movie metadata box.

24. The playing apparatus of claim 23, wherein the movie header data includes at least one of a track (trak) box and a movie extension (mvex) box.

25. A method for recording a media file onto computer-readable recording medium, the method comprising:
generating a box including media data of a first content;
generating a box including metadata information for playing the media data of the first content;
generating a box including media data of a second content;
generating a box including metadata information for playing the media data of the second content; and
storing the generated boxes,
wherein the box including the media data of the second content and the box including the metadata information for playing the media data of the second content each includes identification information for the second content.

26. The method of claim 25, wherein the box including media data of the second content includes a media data (mdat) box.

27. The method of claim 25, wherein the box including metadata information for playing the media data of the second content includes at least one of a file type (ftyp) box, a movie metadata (moov) box, and a movie fragment (moof) box.

28. The method of claim 25, wherein the identification information for the second content is included in header information for identifying the box including the media data of the second content and the box including the metadata information for playing the media data of the second content, respectively.

29. The method of claim 25, wherein the identification information for the second content includes a content identifier for identifying the second content corresponding to the media data contained in a payload of the box, or identifying the second content corresponding to the metadata of the media data.

30. The method of claim 25, wherein the header information includes at least one of information indicating a spatial relationship on a screen between the first content and the second content, information indicating a time relationship between the first content and the second content, and information indicating a semantic of the second content with respect to the first content.

31. A method for recording a media file, the method comprising:
generating a first movie metadata (moov) box corresponding to a first media data (mdat) box corresponding to first content among a plurality of content and a first movie fragment (moof) box;
generating a second movie metadata box, which corresponds to a second media data box corresponding to second content, different from the first content, from among the plurality of content and a second movie fragment box; and
storing the generated first and second media data boxes, first and second movie fragment boxes, and first and second movie metadata boxes,
wherein movie header data in the a second movie metadata box is different from movie header data included in the first movie metadata box.

32. The method of claim 31, wherein the movie header data includes at least one of a track (trak) box and a movie extension (mvex) box.

33. A method for playing a media file, the method comprising:
receiving a box including media data of a first content;
receiving a box including metadata information for playing the media data of the first content;
receiving a box including media data of a second content;
receiving a box including metadata information for playing the media data of the second content;
parsing, from the received boxes, identification information for identifying the second content;
parsing the media data of the second content and the metadata information for playing the media data of the second content according to the identification information; and
processing the media data to be displayed, using the parsed metadata information.

34. The method of claim 33, wherein the box including media data of the second content includes a media data (mdat) box.

35. The method of claim 33, wherein the box including metadata information for playing the media data of the second content includes at least one of a file type (ftyp) box, a movie metadata (moov) box, and a movie fragment (moof) box.

36. The method of claim 33, wherein the identification information is included in header information.

37. The method of claim 33, wherein the identification information includes a content identifier for identifying the second content corresponding to the media data contained in a payload of the box, or identifying the second content corresponding to the metadata of the media data.

38. The method of claim 33, wherein the header information includes at least one of information indicating a spatial relationship on a screen between the first content and the second content, information indicating a time relationship between the first content and the second content, and information indicating a semantic of the second content with respect to the first content.

39. A method for playing a media file, the method comprising:
receiving a box including media data of each content and a stream including metadata information for playing the media data, for each of a plurality of content;
parsing, from the stream, a first movie metadata (moov) box corresponding to a first media data (mdat) box corresponding to first content among the plurality of content and a first movie fragment (moof) box, and
parsing a second movie metadata box, which corresponds to a second media data box corresponding to second content, different from the first content, from among the plurality of content and a second movie fragment box; and
displaying the parsed media data,
wherein movie header data in the a second movie metadata box is different from movie header data included in the first movie metadata box.

40. The method of claim 39, wherein the movie header data includes at least one of a track (trak) box and a movie extension (mvex) box.
